(19) United States
(12) Patent Application Publication
(10) Pub. No.: US 2005/0052024 A1
(43) Pub. Date: Mar. 10, 2005

(54) Coupling means for multi-wall pipes or tubes

(76) Inventor: Fox John Herrington, Bloomfield, NY (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/657,201

(22) Filed: Sep. 9, 2003

(51) Int. Cl. F16L 9/00; F16L 21/00

(52) U.S. Cl. 285/374; 138/109; 285/231

(57) ABSTRACT

This is a method of coupling together lengths of ribbed multi-wall pipe and the coupled pipe resulting from practicing the method. For a length of about ½ diameter at the end of a tube, the inner wall is heated and forced outward and sealed to the solid outer wall, producing an enlarged inside diameter while maintaining the outside diameter constant. At the opposite end of the tube, for a similar length, the outer wall is heated and forced inward and sealed to the solid inner wall, producing a reduced outside diameter and a constant inside diameter. The resulting sizes are such that the small end can be inserted into the large end making the joint. A gasket material can be disposed in the joint.

This invention relates to means for coupling discrete lengths of multi wall pipe or tubing. It more particularly refers to a length of multi wall piping having a male end and a female end that are adapted to be joined to other lengths of pipe that are similarly structured. It is further directed to lengths of pipe or tubing thus coupled. It is further directed to apparatus that can be used for producing male and female ends, respectively, for lengths of pipe or tubing that enable the male and female ends of tandem arranged pipe or tubing, respectively, to fittingly engage each other.

### BACKGROUND OF THE INVENTION

While it is well know to produce extended length pipe or tubing that is sold in coils, it is also usual for piping to be made in discrete lengths which are intended to be coupled in the field to make extended lengths of joined pipe. Whether the pipe is put up in discrete lengths or as a long length coil, there is, and always has been, a need for means to join the ends of pipe together.

These requirements for end coupling have been satisfied in the past by conventional bell and spigot joints or the use of couplings. Often the pipe ends are joined with a gasket material between the pipe sections so as to prevent, or at least minimize, leakage. While these joining structures have been well known in the past, they have usually been used with smooth, single wall pipe. With the advent of pipe having multiple spaced apart walls (see U.S. Pat. No. 6,405,974) which have substantial space between the inner and outer walls, the joining of the pipe ends has become a much more difficult task.

Underground drainage pipe is usually made up of a plurality of discrete pipe sections joined together in whatever geometric configuration is required for a particular task. One such coupling device for assembling together individual lengths is a “bell and spigot” joint, in which one end of the pipe is formed outward as a bell end, that is, the bell end of the pipe is expanded so that its inside diameter is substantially the same as the outside diameter of the remainder of the pipe length. Thus pipe lengths disposed in tandem can be assembled by inserting the non-bell end of one pipe length into the bell end of the next pipe and the opposite end of a next adjacent length of pipe is inserted into the bell. Typically a gasket is used as a seal in the joint. It has been found to be difficult, if not impossible, to reconfigure the end of a multi walled pipe having space between the concentric walls that make up the pipe, so as to form a conventional bell having an inside diameter that is substantially the same as the outside diameter of the rest of the pipe.

Present day conventional dual-wall corrugated plastic pipe is made by vacuum forming a smooth walled pipe to deform the smooth pipe wall onto corrugations. These corrugations can be helical or circular. The vacuum forming operation then converts a smooth walled pipe to a pipe having undulations both inside and outside that correspond to the corrugations that have been formed therein. In order to make the corrugated pipe less resistant to the passage of fluids there through, an inner wall is then extruded over the inner portions of the corrugations so as to form a smooth inside surface and thus make a dual wall pipe; i.e., the outer wall of the finished pipe is corrugated and the inner wall is of substantially constant diameter.

Lengths of these corrugated, dual walled pipes are assembled by deforming a small portion of the length of the dual wall pipe into a bell. To produce the bell end, the mold that forms the corrugations is altered in the region that will be the end of the pipe so that in place of corrugations the outer wall is deformed (suitably thermoformed) outward to make a larger diameter at that location. After the now corrugated pipe is thus formed with a bell end, the inner wall is made smooth by extruding a second layer into the pipe thus covering the internal corrugations. The corrugated pipe is then cut to length. The inner wall in the vicinity of the bell is cut away, leaving an enlarged cavity having an inner diameter that substantially matches the outer diameter of the main portion of the corrugated pipe so that the end of an tandem adjacent pipe that has not been expanded will fit into the expanded bell and form the joint.

A dual-wall pipe of a different structure than the dual walled corrugated pipe referred to above, has now become available. This pipe has an inner wall and an outer wall that are spaced apart with a plurality of rib members disposed in supporting and spacing relationship to the inner and outer walls of the pipe. In one embodiment of this newer dual walled pipe, the inner wall, the outer wall and the plurality of ribs are twisted so as to deform them into a helical pipe. This dual walled pipe can be, and preferably is, smooth walled both inside and out.

In a preferred method of making a dual walled pipe, the material making up the inner wall, the outer wall and the rib members is extruded continuously and continuously twisted into a suitable helical shape. The thus twisted, dual walled pipe is then cut into desired lengths. It is clear that it will be difficult, if not impossible to work on modifying the structure (inside and outside diameters) of the dual wall, twisted pipe length ends during the extrusion process so as to make a male and a female end, respectively, that will be suitable for forming a joint. Therefore, it will be necessary to deform the ends of the individual lengths of pipe or tubing after they are solidified and cut to length.

A problem that has been encountered in producing a bell end on a solidified plastic pipe is that the plastic has memory, so it tends to return to its original size. This has been experienced when the plastic pipes are left outdoors exposed to sunlight, for example. So even though the bell end is formed to a proper size, it does not remain at that size until it is installed.

One possible way to create a bell end that does not change with time is to fully melt the plastic so that all orientation is relaxed and it loses its memory, and then hold it in place while it solidifies. That is essentially what is done with the conventional dual wall pipe, in which the bell is created directly from the original molten plastic. With an extruded, twisted pipe, such as the one described in the referenced '974 patent, this is a very difficult task. Although other methods of forming a bell pipe end have been proposed, it is not believed that any of these have been successful. For example, one proposed method is to form the bell by stretching the pipe material to a diameter that is substantially greater than the desired diameter of the bell, and then allow it to shrink back to its target size as it cools and solidifies. This method has been found to be unreliable because it relies on estimating the amount of over-stretch to use so that as the memory takes over during cooling and solidification, it will shrink back the exact amount needed to form a fluid tight coupling.

In the multi wall pipes that have been described in the '974 patent, it is clear that the overall thickness of the two walls and the rib members disposed between them is greater than would be the thickness of a pipe having the same amount of material but disposed as a solid, single wall. Thus, upon first consideration, it would appear that it will be necessary to add more material in order to make a bell pipe end. This is unacceptable because the value of the multi walled pipe of the '974 patent is that it has the same strength for a smaller amount of material, or it has higher strength for the same amount of material.

### OBJECTS AND BRIEF DESCRIPTION OF THE PRESENT INVENTION

It is therefore an object of the present invention to produce a coupling arrangement for a multi walled pipe having its walls maintained in a spaced apart relationship by means of a plurality of spacing ribs attached to both spaced apart walls.

It is another object of this invention to provide discrete lengths of a multi walled pipe having plural walls arranged in radially spaced apart relationship, where the multiple walls are supported by a plurality of ribs disposed between the walls and wherein one end of the pipe length has a male configuration with an outside diameter that is less than the outside diameter of the remainder of the pipe and an inside diameter that is substantially the same as the remainder of the pipe.

It is a further object of this invention to provide discrete lengths of a multi walled pipe having plural walls arranged in radially spaced apart relationship, where the multiple walls are supported by a plurality of ribs disposed between the walls and wherein one end of the pipe length has a female configuration with an outside diameter that is substantially the same as the outside diameter of the remainder of the pipe and an inside diameter that is substantially more than the remainder of the pipe.

It is an object of this invention to provide an apparatus that is adapted to deform at least one end of a dual wall pipe, such as the pipe structure disclosed in the '974 patent or in U.S. Pat. No. 3,379,221, to form a male or female joint, respectively.

Other and additional objects of this invention will become apparent from a consideration of this entire specification including the claims appended hereto.

The proposed coupling method uses the fact that the overall wall thickness of a pipe, comprising multiple walls that are radially spaced apart, is greater than if all of the material of the walls, as well as the supporting ribs, were concentrated in a single wall with a single diameter, by concentrating all of the material, that is all of the material in the multiple (preferably two) walls, as well as in the ribs separating the walls, at the outside wall at one end of the tube, and at the inside wall at the opposite end. Assuming that the pipe has a smooth, linear inside surface and a smooth, linear outside surface before being deformed to produce the male and female ends, it will preferably continue to have such smooth inside and outside surfaces after the ends are deformed and adjacent pipe lengths are assembled in tandem. The coupling design of this invention envisions that, after coupling together two tandem pipe lengths, the inside and outside diameters of the joint will be substantially the same as the inside and outside diameters of the main portion of the pipe sections.

The description herein is of a multi-walled hollow pipe having a single wall male end having a consistent inside diameter, and a single wall female end having a consistent outside diameter. Although this invention is being described in relation to a length of multi walled pipe having one end deformed into a male member and the other end deformed into a female member, such that the male member can be inserted into the female member of a next successive pipe length, it should be understood that this invention also includes the option of deforming the end of a pipe length so that it has male members at both ends, and/or female members at both ends. Such pipe lengths will be adapted to be assembled in alternating tandem relationship.

To form the coupling joint of this invention, at the large (female) end of the multi walled pipe of this invention, the outside wall is maintained in a solid condition and its original outside diameter is maintained, preferably, but not necessarily, by fitting a collar over the end of the outer wall. In some cases, merely keeping the outer wall in a cooled, solid condition will be sufficient to maintain the outside diameter to the pipe length. The inside elements of the dual walled pipe, that is the inner pipe wall and the intermediate rib members, are melted, or at least softened to the point that it can be deformed, and the softened/molten material forced outwardly so as to collapse this material into the outer wall. The softened/melted inner wall and rib elements are sealed together and to the inside surface of the outer wall whereby substantially increasing the thickness of the outer wall in the area being worked on, while maintaining its outside diameter.

The inner wall and rib elements, that have been deformed outwardly to thicken the outer wall and decrease the inside diameter of the inner wall, have a memory that would ordinarily cause this molten material, upon cooling, to shrink back to its former, reduced inside diameter if it were free to do so. However, according to a preferred aspect of this invention, this molten material is held in place by the solid outer wall on one side, and by a structure/means that is compressing the molten inner wall and rib elements and moving this molten material radially outward on the opposite side. After the molten material has been fully amalgamated with the outer wall, the elements holding the molten material in place remain so while the molten material is cooled and solidified. It is to be understood that an inwardly directed portion of the outer wall will also preferably be heated, and perhaps even melted, to an extent necessary to enable the softened/molten material from the inner wall and associated rib elements to adhere to and become consolidate with the outer wall.

The corresponding procedure is carried out at the small, or male, end, except that at the small end, the inner wall is maintained in a cooled, solid condition having an inside diameter that is consistent with the inside diameter of the remainder of the pipe length. The material of the outer wall and rib elements is at least softened and preferably melted, and forced inwardly by suitable means, such as by a structure that is caused to be radially contracted or shrunk, and thus force the softened/molten material inwardly to be merged with the solid inner wall until the molten plastic material cools and solidifies into a single wall comprising the collapsed outer wall and its associated rib elements. It is to be understood that an outwardly directed portion of the inner wall will also preferably be heated, and perhaps even melted, to an extent necessary to enable the molten material from the outer wall and associated rib elements to adhere to and become consolidate with the inner wall.

The amount of material in the inner wall, the outer wall and the rib elements is controlled so that, after consolidating the inner wall and ribs with the cooled outer wall, the resulting portion of the pipe length has an inside diameter that matches the outside diameter of the portion of the pipe length that is created by melting the outer wall and associated rib elements and consolidating this molten material with the solid inner wall. Upon coupling two lengths of pipe through these modified pipe ends the result is a double length of pipe having a substantially consistent inside and outside diameter throughout its length.

When two lengths of pipe are thus assembled through the instant coupling, it is appropriate to size the male and female portions of the coupling joint so that they press fit in a tight, leak proof relationship. A gasket may be inserted between the male and female elements of the coupling joint. Further, it is within the scope of this invention to dispose an adhesive, preferably a water resistant adhesive, between the male and female elements of the couple so that the joint is permanent. Still further, it is considered to be within the scope of this invention to modify the mating surfaces of the male and female elements of this couple to mold or cut threads into them so that the coupling joint can be assembled by screwing the male element into the female element and thereby producing a tight joint. Suitable leak proofing material may be included in between the threads so as to make the joint water tight.

### BRIEF DECRIPTION OF THE DRAWINGS

FIG. 1a is a perspective view of a pipe length having a male coupling joint end;

FIG. 1b is a perspective view of a pipe length having a female coupling joint end;

FIG. 2a is an end view of a pipe length showing an apparatus for making a female coupling joint end;

FIG. 2b is an end view of a pipe length showing an apparatus for making a male coupling joint end;

FIG. 3a is an end view of a pipe length showing another apparatus for making a female coupling joint end;

FIG. 3b is an end view of a pipe length showing another apparatus for making a male coupling joint end;

FIG. 4a is a side sectional view of a pipe length showing an alternative apparatus for making a female coupling joint end;

FIG. 4b is a side sectional view of a pipe length showing an alternative apparatus for making a male coupling joint end;

FIG. 5 is side view of an assembled couple joint according to this invention; and

FIG. 6 is a fragmented perspective view of one piece of the apparatus of this invention.

### DETAILED DESCRIPTION OF THE INVENTION

In the practice of this invention, it is preferred that the joint portion have a length that is not substantially greater than the outer diameter of said pipe. It is most preferred that the joint portion of the instant pipe have a length that is about equal to half a diameter of the pipe. However, the length of the joint should be determined as a function of the diameter and wall thickness of the pipe. The limitations on the length of the joint are a function of the desired strength of the joint and the economics related to how much overlap of materials can be accepted from a cost perspective.

Various methods of forming the interlocking ends of this invention are proposed. For the purpose of ease of understanding of this invention, means for making the large, female, end of the pipe length is described. With certain modifications, that will be described in detail below, the smaller, male, end of the pipe length is created in much the same manner as the larger, female, end of the pipe length.

In one aspect of this invention, the outer wall of a length of dual walled pipe, having rib elements between its inner and outer walls, is contained within a cool metal tube having an inside diameter that matches the outside diameter of the dual walled pipe length. The inner wall, and attendant rib members are heated to melting and the molten material pressed outward an amount sufficient to collapse the rib members and force the molten material toward the outer wall element. The degree to which the inner wall element and associated rib members is forced toward the outer wall element is determined by the ultimate inside diameter that is required of the female portion of the joint, taking into account the outside diameter that will be created in forming the male portion of the joint.

There are several methods of heating the portion of the inner/outer walls and associated rib elements, respectively, to melting and to press this molten material outward or inward, respectively, into consolidation with the outer or inner walls respectively. All of these means, as well as other means that will accomplish the same purpose, alone or in combination, are intended to be included within the scope of this invention.

It is to be understood that, it is preferred to produce the multi walled pipe of this invention by continuous extrusion as set forth in the '974 and '221 patents referred to above, and then to cut this continuous extrudate into suitable lengths. The ends of these pipe lengths are then deformed into male and female structures as aforesaid. However, it is also within the scope of this invention to directly produce the desired lengths of pipe by other molding processes that do not rely on extrusion of a continuous pipe. It is further within the scope of this invention to deform appropriate portions of a continuous extrudate multi walled pipe before it is cut into lengths. For ease of understanding, the description herein has concentrated on working on finite lengths of multi walled pipe or tubing.

It is within the scope of this invention to heat the appropriate wall and associated rib elements of the instant multi walled pipe by substantially any means, alone or in combination, that is convenient, such as for example: blowing air, or another fluid, at a temperature that is high enough to relatively quickly melt the desired portions of the pipe end against the portion of the pipe end that is to be melted; directing a radiant heat source upon the portion of the pipe end that needs to be melted; directing microwave radiation to the portion of the pipe that needs to be melted; heating the mechanism that presses the molten plastic material inwardly or outwardly, respectively; and directing a laser beam against the portions of the multi walled pipe that need to be melted. Other heating means will suggest themselves to those of ordinary skill in the art. It is important that the heating be confined to the areas that will be deformed to produce the male and female, respectively, pipe ends so as to minimize deformation of the portions of the pipe length that do not form the joint.

One aspect of this invention involves melting the inner wall and associated rib members and pressing the molten material outward into consolidation with the outer wall. Substantially any means that will accomplish this result is considered to be within the scope of this invention. Some illustrative means are:
disposing at least one roller, that has a diameter that is smaller than the inside diameter of the pipe length, and that is enabled to be turned about its longitudinal axis within the end of the pipe length. Heating the inner portions of the end of the pipe length and applying outwardly directed force to the roller(s) so that the roller(s) force the molten material outwardly into consolidation with the outer wall. The roller(s) can be spun about their respective axes so as to make their contact with the molten plastic not result in sticking the molten plastic to the roller. The roller assembly and the pipe length are suitably turned with respect to each other so that the combination of the spinning roller(s) and the relative turning of the roller assembly smoothly forces the molten plastic outwardly an amount sufficient to create the desired inside diameter of the female portion of the pipe joint; Either the pipe can be made stationary and the roller assembly rotated about the axis of the pipe, or the roller assembly can be held stationary and the pipe rotated around the axis of the roller assembly, or both.
disposing an expanding mandrel, comprising a group of overlapping segments, within the hollow interior of the multi walled pipe and causing the mandrel to radially expand by radially moving the overlapping segments whereby enlarging the diameter of the mandrel until the mandrel has caused the molten inner wall and associated rib elements to be forced toward the outer wall an amount sufficient to create the desired inner diameter of the female portion of the coupling joint. Here too, the expanding mandrel and the pipe length may be rotated relative to reach other so as to minimize sticking and dragging of the molten material out of its desired location; and
axially forcing a plug, having an outside diameter that is substantially the same as the desired inside diameter of the female joint element, into the end of the dual walled pipe. The plug should preferably have a tapered leading end to center entry of the plug into the hollow interior of the pipe. The timing of the insertion of the plug to fill the hollow of the pipe is arranged so that when the full diameter of the plug is juxtaposed the inner wall and its associated rib elements, these elements have melted or at least softened so that they can be forced outwardly and collapsed outwardly into consolidation with the outer wall.

It will be clear that other outwardly deforming means can be applied to achieve the desired result. In any case, the formation of the inner diameter and shape of the female portion of the pipe end coupling must be coordinated with the formation of the male coupling end as the two elements of the couple joint must nest with each other to make a strong joint. Thus, if a tapered plug is used to form the female portion of the joint, the inside surface of the resulting pipe end will be tapered from a larger diameter at the end of the pipe to a progressively smaller diameter as one proceeds inwardly. In this case, the male portion of the joint must also be tapered in a complementary fashion with its smallest outside diameter being at the end of the pipe length to a progressively larger outside diameter as one proceeds along the pipe length.

Forming the male portion of the coupling joint of this invention can also be accomplished in any manner that is suitable. For example, like the roller(s) disposed in an expanding condition inside the pipe end to form the female portion of the instant pipe joint, a roller, or a plurality of rollers, can be disposed about the outer wall in such condition that as the roller(s) contact the end of the pipe, they force the molten plastic inwardly while rolling around the pipe so as to make a substantially constant outer diameter male member. The pipe and the roller assembly should rotate relative to each other in order to make the new diameters substantially constant about the whole circumference, but this is not an absolute necessity.

In the most preferred current aspect of this invention, the material from which the multi walled pipe is made is high density polyethylene. It will of course be appreciated that substantially any thermoplastic material will serve as the material of construction.

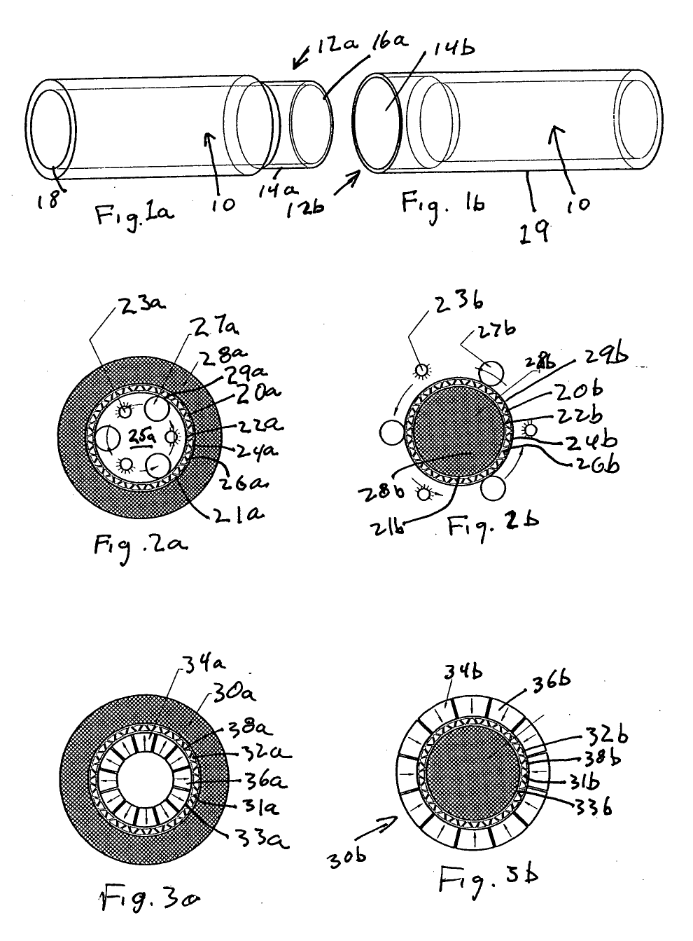

Referring now to the drawing, and particularly FIGS. 1a and b thereof, a hollow pipe length 10, comprising multiple concentric walls (not shown for simplicity), is suitably modified and deformed to convert an end thereof 12a and 12b, respectively, to a male element 14a and a female element 14b. The male element has the same inside diameter 16a as the remainder of the pipe length and the female element has the same outside diameter 16b as the remainder of the pipe length. Thus, in this preferred embodiment, upon joining these two elements in a completed coupling, the total inside diameter 18 and outside diameter 19 will not be changed.

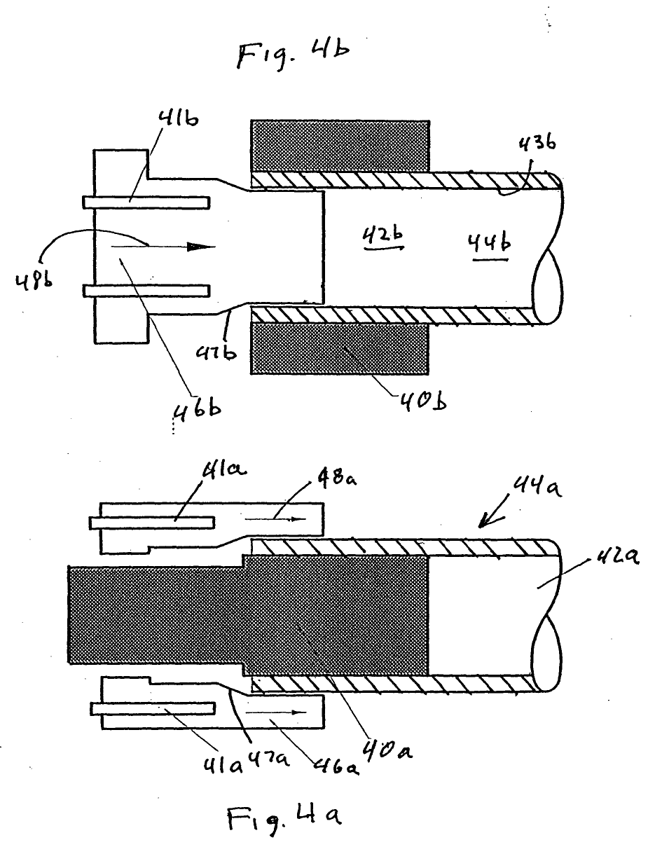

Referring now to FIG. 2a, there is shown an apparatus suited to carrying out one method of forming a female element of a joint coupling according to this invention. The pipe length 20a is made up of an inner tubular wall 22a, an outer tubular wall 24a and a plurality of ribs/ribs 26a. A substantially rigid containment collar 28a is disposed about the periphery of the multi walled pipe in such condition that it preferably maintains the outer diameter 21a of the pipe length solid and constant. Heating elements 23a are disposed within the hollow core 25a of the pipe length and connected to a suitable source of energy (not shown). A plurality of outwardly biased rollers 27a are disposed in outwardly forcing contact with the inwardly directed surface 29a of the inner tubular wall 22a. The pipe 22a and the rollers 27a are rotated relative to each other. As the heating elements 23a softens and melts the inner tubular wall 22a and adjacent ribs 26a, the rollers 27a force the molten mass outwardly into consolidating contact with the inwardly directed wall of the outer tubular wall 24a thereby collapsing the molten mass and joining it to the outer tubular wall and producing a single wall (not shown in this view) from what was a multiple wall structure. This single wall has the same outside diameter as the remainder of the pipe length but now has a larger inside diameter than did the inner tubular wall from which it was made.

Referring now to FIG. 2b, there is shown an apparatus suited to carrying out one method of forming a male element of a joint coupling according to this invention. The multi wall pipe length 20b is made up of an inner tubular wall 22b, an outer tubular wall 24b and a plurality of ribs/ribs 26b disposed in supporting relationship to these walls. A substantially rigid insertion collar 28b is disposed within the hollow of the multi walled pipe in such condition that it preferably maintains the inner diameter 21b of the pipe length solid and constant. Heating elements 23b are disposed about the outwardly directed surface 29b of the outer tubular wall 24b of the pipe length and connected to a suitable source of energy (not shown). A plurality of inwardly biased rollers 27b are disposed in inwardly forcing contact with the outwardly directed surface 29b of the outer tubular wall 24b. The rollers 27b and the pipe 22b are rotated relative to each other. As the heating elements 23b softens and melts the outer tubular wall 24b and adjacent ribs 26b, the rotating rollers 27b force the molten mass inwardly into consolidating contact with the outwardly directed wall of the inner tubular wall 22b thereby collapsing the molten mass and joining it to the inner tubular wall 22b and producing a single wall (not shown in this view) from what had been a multiple wall structure. This single wall has the same inside diameter as the remainder of the pipe length but now has a smaller outside diameter than did the outer tubular wall from which it was made.

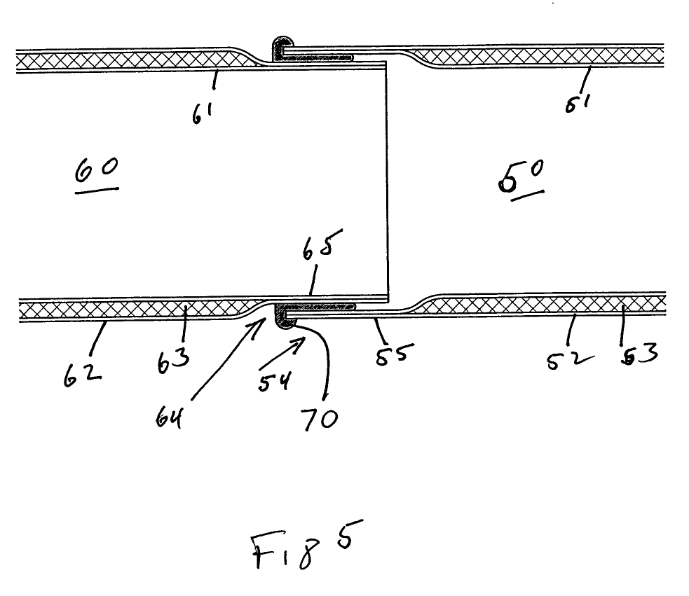

Referring now to FIG. 3a, the female unit of the coupling joint for use with a multi walled pipe is made by operating an apparatus comprising a substantially rigid sleeve 30a that is disposed surrounding an end of a length of pipe 32a. The sleeve is adapted to maintain the outer diameter of the end of the pipe solid and consistent with the outer diameter of the remainder of the length of pipe. In this embodiment of this invention, a mandrel 34a, having overlapping and expanding outer surface elements 36a, is disposed within the hollow of the end of the length of pipe. These expanding surface elements 36a also can serve as heating elements such that they are enabled to heat the inner tubular wall 38a and its adjacent rib elements 31a to form a molten mass. The surface elements are then expanded to force the molten mass into consolidation with the inwardly directed surface of the outer tubular wall 33a, and thereby form a single wall (not shown) having the same outside diameter as the rest of the length of pipe but having an inside diameter that is greater than the inside diameter of the remainder of the pipe length.

Referring now to FIG. 3b, the male unit of the coupling joint for use with a multi walled pipe 30b is made by operating an apparatus comprising a substantially rigid plug 30b that is disposed within the hollow of an end of a length of pipe 32b. The plug is adapted to maintain the inwardly directed surface of the inner tubular wall at the end of the pipe solid and consistent with the inner diameter of the remainder of the length of pipe. In this embodiment of this invention, a collapsing sleeve 34b, having overlapping and contracting inner surface elements 36b, is disposed about the end of the length of pipe and in operative contact with the outwardly directed surface of the outer tubular wall 38b. These contracting surface elements 36b also can serve as heating elements such that they are enabled to heat the outer tubular wall 38b and its adjacent rib elements 31b to form a molten mass. The surface elements are then contracted to force the molten mass into consolidation with the outwardly directed surface of the inner tubular wall 33b, and thereby form a single wall (not shown) having the same inside diameter as the rest of the length of pipe but having an outside diameter that is smaller than the outside diameter of the remainder of the pipe length.

Referring now to the embodiment of this invention shown in FIG. 4a, a male portion of a coupling joint according to this invention is formed by operating the depicted apparatus. In this embodiment, a plug 40a is inserted into the hollow end 42a of a length of dual walled pipe 44a. The outside diameter of the plug matches the inside diameter of the inner tubular wall of the dual walled pipe, whereby the plug maintains the inside diameter constant during the instant procedure and also maintains the inwardly directed wall of the inner tubular wall in a solid condition. A collar 46a is axially aligned with the axis of the pipe length and is adapted to be axially movable 48a in relation to the pipe length. The collar 46a has suitable heating elements 41a, such as resistance heating elements, disposed such that they are adapted to be in operative relationship to the outer tubular wall 43a and its adjacent rib elements 45a of the length of pipe 44a. The pipe and the collar are moved axially toward each other 48a, and the heating elements are engaged whereupon the outer tubular wall and its adjacent rib elements become a molten mass. As the collar and the pipe are moved toward each other, the shoulder 47a of the collar comes into operative contact with the molten mass forcing the molten mass inwardly into consolidation with the inner tubular wall and thereby forming these elements into a single wall having the same inside diameter as the length of pipe but a smaller outside diameter than the remaining pipe length. This then forms the male element of the coupling joint.

Referring now to the embodiment of this invention shown in FIG. 4b, a female portion of a coupling joint according to this invention is formed by operating the depicted apparatus. In this embodiment, a sleeve 40b is disposed about the end 42b of a length of dual walled pipe 44b. The inside diameter of the sleeve matches the outside diameter of the outer tubular wall of the dual walled pipe, whereby the sleeve maintains the outside diameter constant during the instant procedure and also maintains the outwardly directed wall of the outer tubular wall in a solid condition. A plug 46b is axially aligned with the axis of the pipe length and is adapted to be axially movable 48b in relation to the pipe length. The plug 40b has suitable heating elements 41b, such as resistance heating elements, disposed such that they are adapted to be in operative relationship to the inner tubular wall 43b and its adjacent rib elements (not shown) of the length of pipe 44b. The pipe and the collar are moved axially toward each other 48b, and the heating elements are engaged whereupon the inner tubular wall and its adjacent rib elements become a molten mass. As the plug and the pipe are moved toward each other, the shoulder 47b of the plug comes into operative contact with the molten mass forcing the molten mass outwardly into consolidation with the outer tubular wall and thereby forming these elements into a single wall having the same outside diameter as the length of pipe but a larger inside diameter than the remaining pipe length. This then forms the female element of the coupling joint.

Referring now to FIG. 5 of the drawing, there is disclosed an assembled couple joint according to this invention. A first pipe 50 is initially composed of an inner tubular wall 51 radially spaced from an outer tubular wall 52. A plurality of rib elements 53 are disposed in suitable supporting relationship to the radially spaced apart walls. The dual wall structure of the end of the first pipe 54 has been collapsed into a single wall 55 having an outside diameter that is the same as the outside diameter of the remainder of the pipe thus forming a female portion of the coupling.

The second pipe 60 is initially composed of an inner tubular wall 61 radially spaced from an outer tubular wall 62. A plurality of rib elements 63 are disposed in suitable supporting relationship to the radially spaced apart walls. The dual wall structure of the end of the second pipe 64 has been collapsed into a single wall 65 having an inside diameter that is the same as the inside diameter of the remainder of the pipe thus forming a male portion of the coupling.

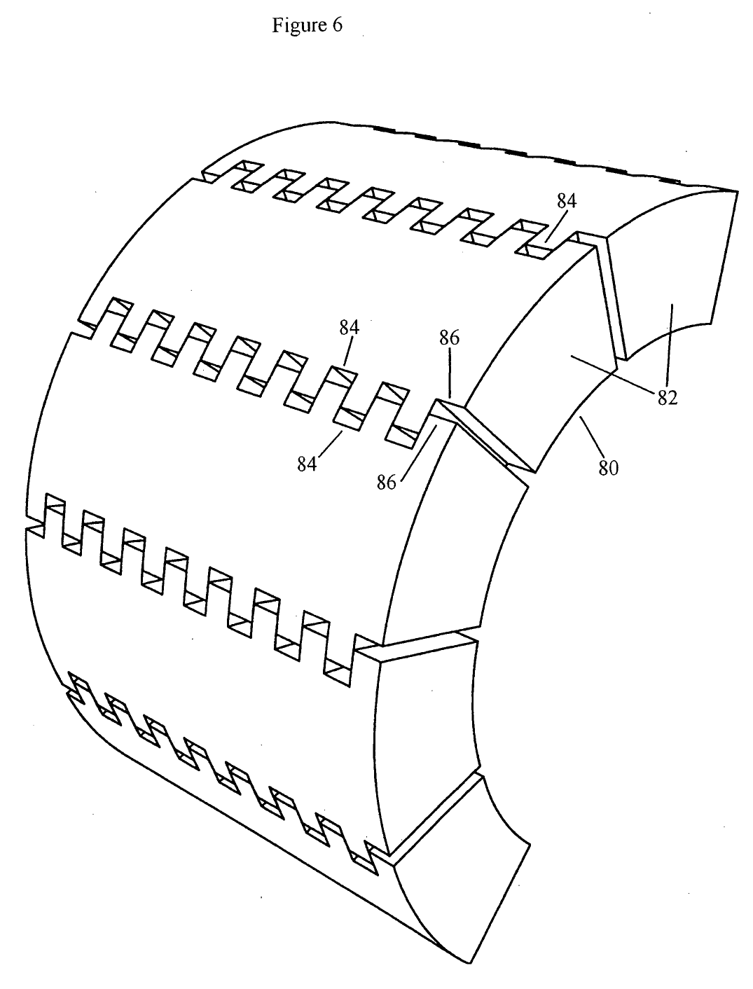

As depicted, the first and the second pipe ends have a gasket material 70 disposed between the male and female coupling members Referring now to FIG. 6, there is shown a perspective view of one piece of “expander-collapser” apparatus that is adapted to helping to make either the female of the male portion of the joint coupling of this invention. This piece of apparatus will be referred to herein as an expander even though it will be clear that it can operate as either an expander, in which case it will assist in making the female member of the joint coupling of this invention, or as a contractor, in which case it will assist in making the male member of the joint coupling of this invention. It will be seen that in FIG. 6, a portion of this piece of apparatus has been broken away in order to make the drawing easier to read. The apparatus shown in FIG. 6 will have an overall cylindrical shape.

For making the male member of the coupling, the cylinder will be hollow with an initial inside diameter that is substantially the same as the outside diameter of the pipe end being collapsed into a male joint coupling member. For making the male member of the joint, the outside diameter of the instant “expander/collapser” member is not critical except that it must be sufficient to enable this member to move inwardly a distance such that the final inside diameter will be somewhat less than the inside diameter of the pipe length end that is being remolded into the male member of the joint coupling.

For making the female member of the coupling, the initial outside diameter of the cylinder will be substantially the same as the inside diameter of the pipe length end that is being reformed. The cylindrical member of this invention will be so designed that the final outside diameter of the expanding element will be somewhat less than the outside diameter of the pipe length that is being reformed.

The difference between the initial outside diameter and the final outside diameter will be the thickness of the female portion of the coupling joint. The difference between the initial inside diameter of the instant cylinder and the final inside diameter of the instant cylinder will be the thickness of the male portion of the instant coupling joint. It will be clear that these thicknesses can be set as desired by the operator.

Referring now to FIG. 6, there is shown an apparatus 80 that is made up of a plurality of cylindrical segments 82 that are adapted to be interleaved. In the specific embodiment disclosed in FIG. 6, each cylindrical segment 82 has a rabbit 84, in a square saw tooth pattern, on each radial edge 86. The teeth of the squared saw tooth design are adapted to interleave with a corresponding squared saw tooth rabbet on the radial end of the next adjacent segment 82.

The instant segmented cylinder is adapted to being “closed” by means (not shown) for driving the segments radially inward. It is adapted to be “opened” by means (not shown) for driving the segments radially outward. This segmented cylindrical, radially moveable, forming tool 80 is adapted to be disposed about the outside of the end portion of a length of multi (suitably dual) walled pipe. The forming tool 80 can be made of a heat conductive material and it is adapted to be heated by any conventional means (not shown). As the heated forming tool is contacted with the end of the length of pipe (not shown), the portion of the plastic pipe that is proximate to the forming tool is melted and forced inwardly, or outwardly, by the forming tool's segments being radially moved inwardly or outwardly, respectively. This action causes the molten material to collapse against, and become joined to, the portion of the multi walled tube that has not been melted whereby forming a single wall from the material that had previously made up the multi walls and the rib members disposed between them.

The segmented cylindrical tool of this invention may be externally heated and thus transfer its heat to the melting of the plastic. Alternatively, heating elements may be incorporated into the appropriate surface of the segments so as to heat the plastic of the multi walled pipe. Radiant heating can be used as well.

The segmented cylindrical tool of this invention is suitably rotatable with respect to the multi walled pipe. Either the pipe can be rotated with the roller being held still, or the roller may be rotated with the pipe being held still, or some combination of the two. In a preferred embodiment of this invention, the multi walled pipe is helically configured by being twisted and pulled down stream after having been extruded. It is within the scope of this invention to utilize this twisting, helical progression of the extrudate to provide the relative turning between the pipe and the segmented cylindrical tool. However, this is not an essential characteristic of this invention.

It will be apparent that, as the segmented forming tool of this invention turns and reforms the end(s) of the multi walled tube of this invention, molten plastic may become introduced into the area between the male members of the rabbit of one segment and the female member of the interlocking rabbit of the next adjacent segment. Plastic material that thus enters this area can become sufficient to interfere with the collapsing or expanding motion of these segments. Therefore, it is considered to be within the scope of this invention that means are provided to remove plastic material that intrudes into the interlocking mesh of adjacent rabbits. This can be accomplished by mechanical means. However, it has been found to be more desirable to either blow hot air through the space between adjacent rabbits and thus dislodge and remove plastic that has intruded, or to apply a vacuum and suck the intruding plastic away. It is preferred to plow hot air in the direction of the multi walled tube that is being reformed so that this “scrap” plastic material becomes reunited with the remainder of the molten material forming the male and female members of the coupling joint.

The extruded tube can be cut into length and the lengths then reformed to product the male and female members of the coupling joint of this invention. Alternatively, the male member of the joint of this invention can be molded into the instant multi walled pipe by the action of a collapsing cylindrical molding member at a point in the progress of the pipe through the forming operations between the place where the extrudate is twisted into a helical shape and the place where the multi walled tube is cooled and solidified. In this embodiment, the segmented cylindrical forming tool would have to be applied to the helical multi walled tube along a longitudinal distance between the twisting of the molten extrudate and the solidification of the twisted extrudate. Where the male member is thus molded into the end of the pipe length, the extrudate will be cut into lengths after the male end has been formed, and long a circumferential line that constitutes the edge between the male member and the next portion of pipe.

### EXAMPLE

A nominal 3 inch diameter, dual walled pipe, having a single inner wall and a single outer wall spaced apart slightly more than 1/4 inch and having a plurality of helically oriented ribs disposed in supporting relationship to the inner and outer walls, was inserted into a pocket in a steel tube. The steel tube was spun in a lathe at 350 RPM and axially rotated the pipe at the same speed. A hot air gun was directed at the inside wall of the plastic pipe for a time sufficient to melt the inside wall and associated rib members. A 1½ inch diameter, freely rotating roller (an idler roller), was mounted in the lathe tool post so that its axis was parallel to the axis of the pipe. The freely rotating roller was pressed outward against the inner wall of the multi walled pipe for a distance of 1½ inches from the end of the tube and held in that position until all of the molten material was collapsed against and adhered to the inwardly directed outer wall of the pipe. The new wall thickness of the single wall at the end of the pipe was about 0.1 inch.

The operation was repeated with a piece of the same dual walled pipe of the same nominal 3 inch diameter disposed over a steel drum that was spun in the lathe. The spinning steel drum drove the pipe at the same speed of 350 RPM. Heat was applied from a heat gun to the outside surface of the dual walled pipe for a time sufficient to cause the outer wall and its associated rib members to melt. The roller was disposed about the outer wall and caused to press the molten material inwardly into adherent contact with the still solid inner wall until the inner wall thickness reached about 0.1 inch and the outer diameter was somewhat less than the inner diameter of the female element referred to above so that the two elements could be nested together to form the finished joint.

The basis weight of the tube was 6.6 ounces per foot, with an overall wall thickness of 0.270 inch. In the 1½″ lengths at the ends of the tube that had been squeezed, overall wall thickness was reduced to about 0.100, while the outside diameter was unchanged at the end that had been squeezed outward, and likewise the inside diameter was unchanged at the end that was squeezed inward. When the small end was inserted into the large end, a gap of 0.070 inch was created. This gap could be filled with gasket material.

The coupling joint of this invention has been disclosed as being male or female. The male portion of the coupling joint has been defined as having an inside diameter that is the same as the inside diameter of the remainder of the pipe. The female portion of the coupling joint has been defined as having an outside diameter that is the same as the outside diameter of the remainder of the pipe. While these are true features of this invention, they are not limiting features. That is, in normal usage, where the assembled, coupled pipes of this invention are intended to be used to carry fluids, such as water, the hydraulic engineer will normally want the assembled pipe to have a constant inside diameter. In the preferred aspect of this invention, the coupling joint elements are so designed as to give the hydraulic engineer what is desired. Similarly, the construction engineer will prefer that the outside diameter of the assembled pipe remain constant for its entire length. In its preferred embodiment, this too is a feature of this invention.

However, it should be readily apparent that the maintenance of a constant inside or outside diameter is not a limitation on this invention. It will be appreciated by those of ordinary skill in this art that the inside and/or the outside diameters of the couple portions of the pipe can be different. The inside diameter of the couple joint can be smaller or larger than the inside diameter of the remainder of the pipe. Similarly, the outside diameter of the couple joint can be greater or less than the outside diameter of the remainder of the pipe. Both the pipe coupling structure, the method of making the pipe coupling of this invention and the apparatus that is used to make this coupling are just as well suited to coupling elements that have the same inside and outside, respectively, diameters as they are to coupling elements where the inside and/or the outside diameters are different from each other and/or different from the remainder of the coupled pipe. These variations are intended to be embraced by this invention as obvious equivalents of the product method and apparatus specifically disclosed herein.

Further, it is pointed out that the pipe lengths that are coupled together according to this invention need not be straight. They may be curved or otherwise shaped in conventional pipe coupling shapes.

Still further, it is pointed out that this invention can also be used to advantage in making and using pipe fittings. For example, it is considered to be within the scope of this invention to joint two pipe ends that have male configurations according to the instant disclosure by using a separate coupling sleeve that is adapted to fit over both of the male coupling elements and to thereby join them. The couplings can be through the use of “T” of “Y” fittings as well as any other shape or style. Similarly, multiple pipe ends having female coupling structures as disclosed herein can be joined through the use of a nipple of suitable diameter and configuration.

Where pipe fittings are used, they may be structured in a conventional, solid manner even though the pipes they are joining are multi wall tubes. Alternatively, the pipe fittings can have structures that are multi-wall in the same manner as is disclosed herein for pipe lengths.

Threaded connections are contemplated by this invention. Where used, threaded couple joints can have the threads molded into the inside and outside diameters, respectively, of the single wall portions of the coupling joint during the formation of these single walls or they may be cut into previously made single wall portions of the instant joints.

1. An assembly of a first length of pipe axially joined to a second length of pipe:
wherein said pipes each comprise an inner tubular wall having a thickness, an outer tubular wall, having a thickness, radially spaced apart from said inner tubular wall, and has a plurality of rib members disposed between said inner tubular wall and said outer tubular wall in a supporting relationship to both said walls;
wherein a portion of said first length of pipe, proximate to and including an end thereof, is configured as a single tubular wall having a thickness that is greater than the thickness of either said outer tubular wall or said inner tubular wall and having an inside diameter that is greater than the inside diameter of the remainder of said pipe;
wherein a portion of the second length of pipe, proximate to and including an end thereof, is configured as a single tubular wall having a thickness that is greater than the thickness of either said outer wall or said inner wall and having an outside diameter that is less than the outside diameter of the remainder of said pipe; and
wherein the outside diameter of the single wall portion of the second length of pipe is not larger than the inside diameter of the single wall portion of the first length of pipe.

2. An assembly as claimed in claim 1 wherein at least some of said ribs are helically oriented and define a plurality of cells each of which is bounded by two adjacent ribs and a portion of at least one of said inner tubular wall and said outer tubular wall.

3. An assembly as claimed in claim 1 wherein at least some of said ribs are slantedly joined to said inner and outer tubular walls at an angle that is not normal to a tangent to said tubular members at the point where the rib is joined to said tubular wall.

4. An assembly as claimed in claim 1 wherein said single wall portion of said second tubular wall is inserted within said single wall portion of said first tubular wall.

5. An assembly as claimed in claim 4 wherein the inside diameter of said single wall portion of said first tubular wall and the outside diameter of said single wall portion of said second tubular wall are substantially the same.

6. An assembly as claimed in claim 1 wherein said single wall portion of said inner tubular wall comprises a part of said inner tubular wall of the same length as said portion, a portion of said ribs disposed in said portion, and a part of said outer tubular wall of the same length as said portion, and wherein said outer wall portion, said inner wall portion and said ribs portion are melted together to form said single wall portion of said inner tubular wall.

7. An assembly as claimed in claim 1 wherein said single wall portion of said outer tubular wall comprises a part of said outer tubular wall of the same length as said portion, a portion of said ribs disposed in said portion, and a part of said inner tubular wall of the same length as said portion, and wherein said inner wall portion, said outer wall portion and said ribs portion are melted together to form said single wall portion of said outer tubular wall.

8. An assembly as claimed in claim 1 further comprising a gasket between at least a portion of proximate said single wall portions.

9. A length of pipe comprising an inner tubular wall, and outer tubular wall radially spaced from said inner tubular wall, and a plurality of rib members disposed between and in supporting relationship to said inner and outer tubular walls;
further comprising an end of said pipe length and a portion of said pipe proximate to said end consisting of a single wall comprising, in combination, the amount of said inner tubular wall of said portion, the amount of said outer tubular wall of said portion and the amount of rib members in said portion; and
wherein said inner tubular wall of said portion, said outer tubular wall of said portion and said rib members in said portion are consolidated together to form said single wall.

10. A length of pipe as claimed in claim 9 further comprising said end structure at both ends of said pipe.

11. A length of pipe as claimed in claim 9 wherein said single wall has an outside diameter that is substantially the same as the outside diameter of the remainder of said length of pipe.

12. A length of pipe as claimed in claim 9 wherein said single wall has an inside diameter that is substantially the same as the inside diameter of the remainder of said length of pipe.

13. A length of pipe as claimed in claim 10 wherein said single wall at one end of said pipe has an outside diameter that is substantially the same as the outside diameter of the remainder of said pipe and the single wall at the other end of said pipe has an inside diameter that is substantially the same as the inside diameter of the remainder of said pipe.

14. A length of pipe as claimed in claim 10 wherein said single walls at both ends of said pipe have inside diameters that are substantially the same as the inside diameter of the remainder of said pipe.

15. A length of pipe as claimed in claim 10 wherein said single walls at both ends of said pipe have outside diameters that are substantially the same as the outside diameter of the remainder of said pipe.

16. A method of providing half of a coupling structure at one end of a pipe, wherein said pipe comprises an inner tubular wall, and outer tubular wall radially spaced from said inner tubular wall, and a plurality of rib members disposed in supporting relationship between said inner and outer walls, which method comprises:
at least softening, into an adherent condition, a portion of said outer tubular wall comprising an end of said pipe and a portion of said outer tubular wall proximate to said pipe end and at least softening, into an adherent condition, at least part of said rib members in said portion to form a moldable, adherent mass;
maintaining at least an inwardly directed portion of said inner tubular wall in a solid, unmoldable condition;
consolidating at least a portion of said moldable mass with said inner wall to form a consolidated single wall; and
cooling said consolidated single wall into a solidified wall having an inside diameter that is substantially the same as the inside diameter of the remainder of said pipe.

17. The method as claimed in claim 16 further comprising causing an outside diameter of said single wall to be less than the outside diameter of the remainder of said pipe.

18. The method as claimed in claim 16 further comprising causing an outside diameter of said single wall to be not more than the outside diameter of the remainder of said pipe less at least half of the thickness of the multi wall structure of said pipe.

19. The method as claimed in claim 16 further comprising at least softening said portion of said outer tubular wall and a portion of said rib members by impinging a hot fluid against them for a time sufficient to cause said melting.

20. The method as claimed in claim 16 further comprising at least softening said portion of said outer tubular wall and a portion of said rib members by subjecting them to incident radiant heating energy for a time sufficient to cause said melting.

21. The method as claimed in claim 16 further comprising at least softening said portion of said outer tubular wall and a portion of said rib members by impinging microwave energy against them for a time sufficient to cause said melting.

22. The method as claimed in claim 16 further comprising at least softening said portion of said outer tubular wall and a portion of said rib members by subjecting them to laser bombardment for a time sufficient to cause said melting.

23. The method as claimed in claim 16 further comprising at least softening said portion of said outer tubular wall and a portion of said adjacent rib members by transferring heat from an element, that is adapted to move said at least softened mass inwardly toward said inner tubular wall.

24 The method as claimed in claim 16 wherein said heating is sufficient to melt said outer wall and adjacent rib members into a molten mass.

25. A method of providing half of a coupling structure at one end of a pipe, wherein said pipe comprises an inner tubular wall, and outer tubular wall spaced from said inner tubular wall, and a plurality of rib members disposed in supporting relationship between said inner and outer walls, which method comprises:
at least softening a portion of said inner tubular wall comprising an end of said pipe and a portion of said pipe proximate to said pipe end, and at least softening at least part of said rib members in said portion of said pipe to form a softened, adherent mass;
maintaining at least an outwardly directed portion of said outer tubular wall in a solid, unsoftened condition;
consolidating at least a portion of said at least softened mass with said outer wall to form a consolidated single wall; and
cooling said consolidated single wall into a solidified wall having an outside diameter that is substantially the same as the outside diameter of the remainder of said pipe.

26. The method as claimed in claim 25 further comprising causing an inside diameter of said single wall to be greater than the inside diameter of the remainder of said pipe.

27. The method as claimed in claim 25 further comprising causing an inside diameter of said single wall to be the sum of the inside diameter of the remainder of said pipe plus about half the thickness of the multi wall structure.

28. The method as claimed in claim 25 further comprising at least softening said portion of said inner tubular wall and a portion of said rib members by impinging a hot fluid against them for a time sufficient to cause said at least softening.

29. The method as claimed in claim 25 further comprising at least softening said portion of said inner tubular wall and a portion of said rib members by subjecting them to incident radiant heating energy for a time sufficient to cause said at least melting.

30. The method as claimed in claim 25 further comprising at least softening said portion of said inner tubular wall and a portion of said rib members by impinging microwave energy against them for a time sufficient to cause said at least softening.

31. The method as claimed in claim 25 further comprising at least softening said portion of said outer tubular wall and a portion of said rib members by subjecting them to laser bombardment for a time sufficient to cause said at least softening.

32. The method as claimed in claim 25 further comprising at least softening said portion of said inner tubular wall and at least a portion of said rib members adjacent thereto by transferring heat from an element, that is adapted to move said softened mass outwardly toward said outer tubular wall.

33. The method as claimed in claim 25 wherein said heating is sufficient to melt said inner wall and said adjacent rib members into a molten mass.

34. A method as claimed in claim 16 further comprising consolidating said molten mass with said inner tubular wall by:
causing at least the inwardly directed portion of said inner tubular wall to be maintained in a solid condition;
disposing at least one roller outward of said outer tubular wall and in engaging relationship thereto;
upon forming said molten mass, engaging said roller(s) with said molten mass and causing said roller(s) to collapse said molten mass onto an outwardly directed surface of said inner tubular wall; and
cooling said molten mass while it is maintained consolidated with said inner tubular wall for a time sufficient to solidify said consolidated mass to form said single wall.

35. A method as claimed in claim 25 further comprising consolidating said molten mass with said outer tubular wall by:
causing at least the outwardly directed portion of said outer tubular wall to be maintained in a solid, unmelted condition;
disposing at least one roller inward of said inner tubular wall and in engaging relationship thereto;
engaging said roller(s) with said molten mass and causing said roller(s) to force said molten mass outwardly onto an inwardly directed surface of said outer tubular wall; and
cooling said molten mass while it is maintained consolidated with said outer tubular wall for a time sufficient to solidify said consolidated mass to form said single wall.

36. A method as claimed in claim 25 further comprising consolidating said molten mass with said outer tubular wall by:
causing at least the outwardly directed portion of said outer tubular wall to be maintained in a solid, unmelted condition;
disposing a radially expandable mandrel within said inner tubular wall and in engaging relationship thereto;
engaging said radially expandable mandrel with said molten mass and causing said mandrel to radially expand and to thereby force said molten mass onto an inwardly directed surface of said outer tubular wall; and
cooling said molten mass while it is maintained consolidated with said outer tubular wall for a time sufficient to solidify said consolidated mass to form said single wall.

37. A method as claimed in claim 25 further comprising consolidating said molten mass with said outer tubular wall by:
causing at least the outwardly directed portion of said outer tubular wall to be maintained in a solid condition;
disposing a tapered plug inside said inner tubular wall and in engaging relationship thereto;
engaging said tapered plug with said molten mass and causing said tapered plug to force said molten mass onto an inwardly directed surface of said outer tubular wall; and
cooling said molten mass while it is maintained consolidated with said outer tubular wall for a time sufficient to solidify said consolidated mass to form said single wall.

38. An apparatus, adapted to form a female portion of a coupling joint in an end of a tubular multi walled pipe, wherein said pipe comprises an outer tubular wall, and inner tubular wall radially spaced there from and a plurality of rib elements disposed between and in supporting relationship to said inner and outer tubular walls, said apparatus comprising:
a collar disposed about and in supporting relationship to an outwardly directed surface of said outer tubular wall;
a plug axially aligned with said pipe and comprising at least one shoulder structure sized and positioned to operatively engage said inner tubular wall;
heating means adapted to at least soften said inner tubular wall and adjacent rib elements proximate to the end of said pipe to form an at least softened mass, but not to soften said outwardly directed surface of said outer tubular wall and amount sufficient to distort that surface;
means to axially engage said plug with said pipe end whereby enabling said shoulder(s) to deform and collapse said at least softened mass into consolidation with said outer tubular wall and to thereby form a single wall section of said pipe including an end of said pipe and a portion of said pipe proximate to said end;
wherein said single wall section has an outer diameter that is substantially the same as the outer diameter of the remainder of said pipe and an inner diameter that is larger than the inner diameter of the remainder of said pipe; and
means to disengage said heating means and to maintain said plug, pipe end and collar in operative association for a time sufficient to enable said single wall element to solidify and to maintain its deformed position.

39. The apparatus as claimed in claim 38 wherein said heating means is at least one member selected from the group consisting of: radiant heating, resistance heating, microwave heating, laser heating and hot fluid impingement heating.

40. The apparatus as claimed in claim 38 wherein said heating means is sufficient to cause said inner tubular wall and adjacent rib elements to form a molten mass.

41. An apparatus, adapted to form a male portion of a coupling joint in an end of a tubular multi walled pipe, wherein said pipe comprises an outer tubular wall, and inner tubular wall radially spaced there from and a plurality of rib elements disposed between and in supporting relationship to said inner and outer tubular walls, said apparatus comprising:
a plug adapted to be disposed within the hollow of said pipe and in supporting relationship to an inwardly directed surface of said inner tubular wall;
an axially movable collar axially aligned with said pipe and comprising at least one shoulder structure sized and positioned to operatively engage said outer tubular wall;
heating means adapted to at least soften said outer tubular wall and adjacent rib elements proximate to the end of said pipe to form an at least softened mass, but not to deform said inwardly directed surface of said inner tubular wall;
means to axially engage said collar with said pipe end whereby enabling said shoulder(s) to deform and collapse said at least softened mass into consolidation with said inner tubular wall and to thereby form a single wall section of said pipe including an end of said pipe and a portion of said pipe proximate to said end;
wherein said single wall section has an outside diameter that is smaller than the outside diameter of the remainder of said pipe and an inside diameter that is substantially the same as the inside diameter of the remainder of said pipe; and
means to disengage said heating means and to maintain said plug, pipe end and collar in operative association for a time sufficient to enable said single wall element to solidify and to maintain its deformed position.

42. The apparatus as claimed in claim 41 wherein said heating means is at least one member selected from the group consisting of: radiant heating, resistance heating, microwave heating, laser heating and hot fluid impingement heating.

43. The apparatus as claimed in claim 41 wherein said heating means is sufficient to form said outer tubular wall and adjacent rib members into a molten mass

44. An apparatus, adapted to form a female portion of a coupling joint in an end of a tubular multi walled pipe, wherein said pipe comprises an outer tubular wall, and inner tubular wall radially spaced there from and a plurality of rib elements disposed between and in supporting relationship to said inner and outer tubular walls, said apparatus comprising:
a collar disposed about and in supporting relationship to an outwardly directed surface of said outer tubular wall;
a mandrel, having a radially outwardly expandable outer circumference, axially aligned with said pipe and disposed within the hollow of said pipe;
heating means adapted to at least soften said inner tubular wall and adjacent rib elements proximate to the end of said pipe to form an at least softened mass, but not to melt said outwardly directed surface of said outer tubular wall;
means to axially engage said mandrel with said pipe end and means to radially outwardly expand the surface of said mandrel whereby deforming and collapsing said at least softened mass into consolidation with said outer tubular wall and to thereby form a single wall section of said pipe including an end of said pipe and a portion of said pipe proximate to said end;
wherein said single wall section has an outer diameter that is substantially the same as the outer diameter of the remainder of said pipe and an inner diameter that is larger than the inner diameter of the remainder of said pipe; and
means to disengage said heating means and to maintain said mandrel, pipe and collar in operative association for a time sufficient to enable said single wall element to solidify and to maintain its deformed position.

45. The apparatus as claimed in claim 44 wherein said heating means is at least one member selected from the group consisting of: radiant heating, resistance heating, microwave heating, laser heating and hot fluid impingement heating.

46. The apparatus as claimed in claim 45 wherein said heating means is sufficient to melt said inner tubular wall and adjacent rib members into a molten mass.

47. An apparatus, adapted to form a male portion of a coupling joint in an end of a tubular multi walled pipe, wherein said pipe comprises an outer tubular wall, and inner tubular wall radially spaced there from and a plurality of rib elements disposed between and in supporting relationship to said inner and outer tubular walls, said apparatus comprising:
a plug adapted to be disposed within the hollow of said pipe and in supporting relationship to an inwardly directed surface of said inner tubular wall;
a collar, having an inwardly collapsible surface, sized and positioned to operatively engage said outer tubular wall, directed toward said outer tubular wall and axially aligned with said pipe;
heating means adapted to at least soften said outer tubular wall and adjacent rib elements proximate to the end of said pipe to form an at least softened molten mass, but not to distort said inwardly directed surface of said inner tubular wall;
means to axially engage said inwardly collapsible surface of said collar with said outer tubular wall;
means to inwardly collapse said collar, whereby deforming and collapsing said at least softened mass into consolidation with said inner tubular wall and to thereby form a single wall section of said pipe including an end of said pipe and a portion of said pipe proximate to said end;
wherein said single wall section has an outside diameter that is smaller than the outside diameter of said pipe and an inside diameter that is substantially the same as the inside diameter of said pipe; and
means to disengage said heating means and to maintain said plug, pipe and collar in operative association for a time sufficient to enable said single wall element to solidify and to maintain its deformed position.

48. The apparatus as claimed in claim 47 wherein said heating means is adapted to melt said outer tubular wall and adjacent rib elements.

49. The apparatus as claimed in claim 47 wherein said heating means is at least one member selected from the group consisting of: radiant heating, resistance heating, microwave heating, laser heating and hot fluid impingement heating.

50. An apparatus, adapted to form a female portion of a coupling joint in an end of a tubular multi walled pipe, wherein said pipe comprises an outer tubular wall, and inner tubular wall radially spaced there from and a plurality of rib elements disposed between and in supporting relationship to said inner and outer tubular walls, said apparatus comprising:
a collar disposed about and in supporting relationship to an outwardly directed surface of said outer tubular wall;
at least one roller, having an axis that is substantially parallel to the axis of said pipe, adapted to be disposed within the hollow of said pipe and adapted to be in operative contact with said inner tubular wall;
wherein said roller(s) is adapted to exert outward pressure on said inner tubular wall;
heating means adapted to at least soften said inner tubular wall and adjacent rib elements proximate to the end of said pipe to form a molten mass, but not to deform said outwardly directed surface of said outer tubular wall;
means to rotate said pipe and said roller(s) with respect to each other;
means to engage said roller(s) with said at least softened mass and to outwardly deform and collapse said at least softened mass into consolidation with said outer tubular wall and to thereby form a single wall section of said pipe including an end of said pipe and a portion of said pipe proximate to said end;
wherein said single wall section has an outer diameter that is substantially the same as the outer diameter of the remainder of said pipe and an inner diameter that is larger than the inner diameter of the remainder of said pipe; and
means to disengage said heating means and to maintain said rotating roller(s), pipe and collar in operative association for a time sufficient to enable said single wall element to solidify and to maintain its deformed position.

51. The apparatus as claimed in claim 50 wherein said heating means is at least one member selected from the group consisting of: radiant heating, resistance heating, microwave heating, laser heating and hot fluid impingement heating.

52. The apparatus as claimed in claim 50 wherein said heating means is adapted to melt said inner tubular wall and adjacent rib elements.

53. An apparatus, adapted to form a male portion of a coupling joint in an end of a tubular multi walled pipe, wherein said pipe comprises an outer tubular wall, and inner tubular wall radially spaced there from and a plurality of rib elements disposed between and in supporting relationship to said inner and outer tubular walls, said apparatus comprising:
a plug adapted to be disposed within the hollow of said pipe and in supporting relationship to an inwardly directed surface of said inner tubular wall;
at least one roller having an axis that is substantially parallel to the axis of said pipe, adapted to be disposed in operative contact with said outer tubular wall;
heating means adapted to at least soften said outer tubular wall and adjacent rib elements proximate to the end of said pipe to form an at least softened mass, but not to distort said inwardly directed surface of said inner tubular wall;
means to rotate said pipe and said roller(s) with respect to each other;
means to engage said roller(s) with said at least softened mass whereby to force said at least softened mass inwardly and to collapse said at least softened mass and consolidate said at least softened mass with said inner tubular wall to form a single wall section of said pipe;
wherein said single wall section has an outside diameter that is smaller than the outside diameter of said pipe and an inside diameter that is substantially the same as the inside diameter of said pipe; and
means to disengage said heating means and to maintain said plug, pipe and collar in operative association for a time sufficient to enable said single wall element to solidify and to maintain its deformed position.

54. The apparatus as claimed in claim 53 wherein said heating means is sufficient to melt said outer tubular wall and adjacent rib elements.

55. The apparatus as claimed in claim 53 wherein said heating means is at least one member selected from the group consisting of: radiant heating, resistance heating, microwave heating, laser heating and hot fluid impingement heating.

56. A substantially cylindrical article comprising:
a plurality of radially disposed segments, wherein at least some of said segments are adapted to interlock with a next adjacent segment through an interwoven rabbit structure, wherein said segments are adapted to move radially with respect to the axis of said cylindrical article and in so moving collapse or expand the interlocked fingers of said rabbits whereby being adapted to decrease or increase, respectively, the effective diameter of said article;
means to heat said segments to an extent necessary to mold a thermoplastic material; and
means to mold said thermoplastic material into a shaped article by radially moving said segments while said thermoplastic material is heated to a molding temperature.

57. The cylindrical article as claimed in claim 56 wherein said cylinder is hollow.

58. The cylindrical article as a claimed in claim 56 further comprising:
said multi walls being radially spaced from each other;
means to insert said article into the interior of a multi walled plastic pipe;
means to place an outside circumference of said cylindrical article into contact with an inside circumference of said pipe;
means to heat at least an outside circumference of said cylindrical article to a temperature at which the material of said inside circumference of said pipe is moldable;
means to radially expand said cylindrical segments into contact with said inside circumference of said pipe and to thereby convert said inside circumference of said pipe into a moldable condition;
means to further radially expand said cylindrical segments whereby forcing said moldable inside circumference of said pipe radially outwardly and into contact with a radially outer wall and to join said moldable inside circumference with said outer wall to form a single wall section of said pipe.

59. The cylindrical article as a claimed in claim 56 further comprising:
said multi walls being radially spaced from each other;
means to dispose said article about the outside periphery of a multi walled plastic pipe;
means to place an inside circumference of said cylindrical article into contact with an outside circumference of said pipe;
means to heat at least an inside circumference of said cylindrical article to a temperature at which the material of the outside surface of said pipe is moldable;
means to radially contract said cylindrical segments into contact with said outside circumference of said pipe and to thereby convert said outside circumference of said pipe into a moldable condition;
means to further radially contract said cylindrical segments whereby forcing said moldable inside circumference of said pipe radially inwardly and into contact with a radially inner wall and to join said moldable outside circumference with said inner wall to form a single wall section of said pipe.

60. The cylindrical article as claimed in claim 56 further comprising means to heat at least a surface of said cylindrical sections.

61. The cylindrical article as claimed in claim 56 further comprising means to inject a fluid under pressure into the space between said interlocking rabbits; wherein said pressure is sufficient to eject foreign material disposed in said space.

62. The cylindrical article as claimed in claim 56 further comprising means to draw a vacuum from the space between said interlocking rabbits; wherein said vacuum is sufficient to suck out foreign material disposed in said space.

63. The cylindrical article as claimed in claim 56 wherein said heating is supplied by at least one member selected from the group consisting of: contact with a hot fluid; incident radiant heating, impinging microwave energy, laser bombardment, electrical resistance heating, and electrical inductance heating.
